(19) United States
(12) Patent Application Publication
(10) Pub. No.: US 2010/0117383 A1
(43) Pub. Date: May 13, 2010

(54) DOOR STRIKE

(75) Inventors: Trevor Mackle, New South Wales (AU); David Chang, Fengxian (CN)

Correspondence Address: LADAS & PARRY LLP, 224 SOUTH MICHIGAN AVENUE, SUITE 1600, CHICAGO, IL, 60604, US

(73) Assignee: SHANGHAI ONE TOP CORPORATION, Fengxian (CN)

(21) Appl. No.: 12/377,292

(22) PCT Filed: Aug. 16, 2007
(86) PCT No.: PCT/AU2007/001164

§ 371 Date: Jan. 11, 2010

(30) Foreign Application Priority Data
Aug. 17, 2006 (AU) 2006904478
Nov. 17, 2006 (AU) 1006906441

(51) Int. Cl. E05B 15/02; E05B 47/00

(52) U.S. Cl. 292/341.16

(57) ABSTRACT

A door strike including: a latch retainer for retaining a door latch; a lock actuator which operates when power is applied; a mode selector rotatable between at least two positions; in a first position of the mode selector the strike adopts a power to open mode, in the second position of the mode selector the strike adopts a power to lock mode.

### TECHNICAL FIELD

This invention relates to a door strike.

### BACKGROUND TO THE INVENTION

Door strikes are used for controlling access through doors such as fire doors or tenancy entrance doors. A door strike is typically installed into a door jamb and engages with a door latch by way of a keeper. If the keeper is free to move then the door can be opened. If the keeper is not free to move then the strike is said to be “locked”. The keeper traps the door latch and the door can only be opened if the latch can be retracted such as by using a door handle or key. Door strikes are typically electrically powered and utilise a solenoid to actuate the strike mechanism.

An electric door strike can operate in one of two modes “power to look” and “power to open”. In the power to lock mode the keeper is free to move when no power is supplied and becomes locked upon supplying power. In this mode persons are free to pass through doors in the event of a power outage or the like. In the power to open mode the keeper is free to move only when power is supplied and in the absence of power the keeper becomes locked.

### SUMMARY OF THE INVENTION

The present invention provides a door strike including: a latch retainer for retaining a door latch; a lock actuator which operates when power is applied; a mode selector rotatable between at least two positions; in a first position of the mode selector the strike adopts a power to open mode, in the second position of the mode selector the strike adopts a power to lock mode.

The mode selector may include at least two recesses which cooperate with a lug associated with the latch retainer.

The recesses may be provided about a generally cylindrical portion of the mode selector.

The mode selector may include at least two grooves which dictate the at least two positions of the mode selector.

At least one set screw may sit in either of the grooves to retain the mode selector in either of the at least two positions.

The latch retainer may be pivotally mounted in the door strike.

### BRIEF DESCRIPTION OF THE DRAWINGS

An embodiment of the present invention will now be described, by way of example only, with reference to the accompanying drawings, in which:

FIG. 1 is a perspective view of a door strike according to an embodiment of the invention;

FIG. 2 is a cross sectional view illustrating mounting of a door strike in a door frame;

FIG. 3 is a rear view of the strike of FIG. 1 with rear cover removed to expose moving parts of the strike and shown in the power to lock mode with no power applied;

FIG. 4 shows the capstan and keeper of the strike of FIG. 3 in isolation and in a perspective view;

FIG. 5 shows the door strike of FIG. 3 in the power to lock mode with power applied;

FIG. 6 illustrates the door strike of FIG. 3 being changed to the power to open mode;

FIG. 7 shows the door strike of FIG. 3 in the power to open mode with no power applied;

FIG. 8 shows the door strike of FIG. 3 in the power to open mode with power applied;

FIG. 9 is a cross sectional view of the strike of FIG. 3 along line A-A;

FIG. 10 is an illustration of the capstan screw and stopper;

FIG. 11 is a cross sectional view similar to FIG. 9, but showing set screw loosened;

FIG. 12 is a perspective view of an alternative version of capstan for use in a lock according to a further embodiment of the invention; and

FIG. 13 depicts the capstan of FIG. 12 in another position.

### DETAILED DESCRIPTION OF THE PREFERRED EMBODIMENT

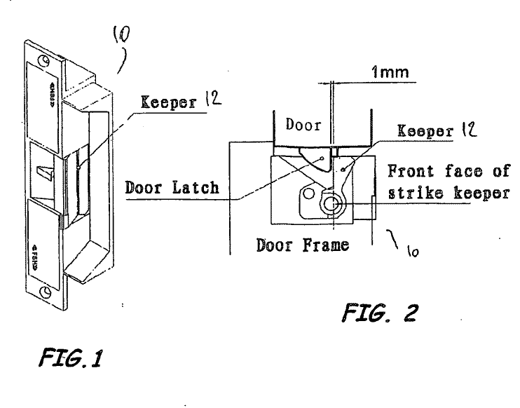

Referring to FIG. 1, a door strike 10 is shown in perspective view. The door strike is installed in a door frame in use (see FIG. 2) and receives a door latch in a recess bounded on one side by a latch retainer in the form of keeper 12. If keeper is free to move, then the door can be opened without retracting the door latch. If the keeper is not free to move, then the door latch must be retracted to allow the door to open. This may necessitate the use of a key or the like to withdraw the door latch.

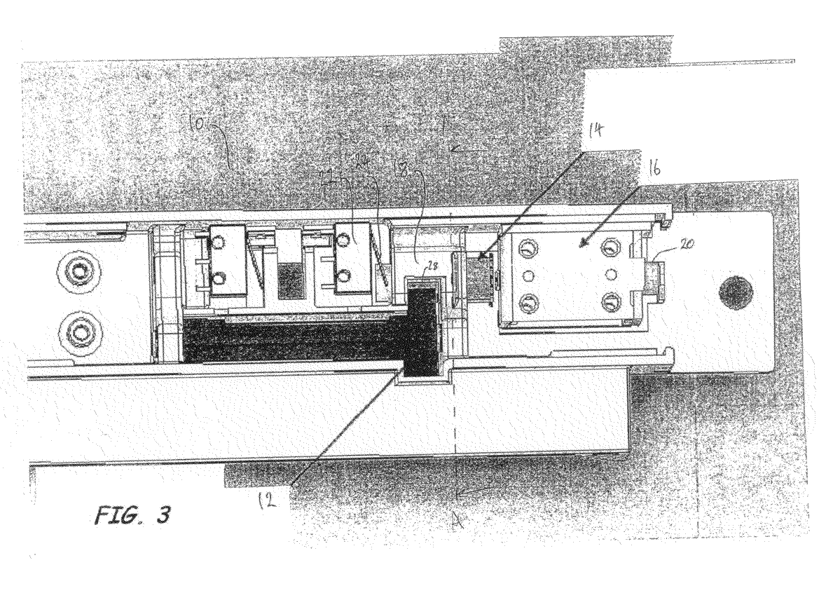

Referring to FIG. 3, door strike 10 is shown including keeper 12 for retaining a door latch. Strike 10 further includes a mode selector in the form of capstan 14, and a lock actuator in the form of solenoid 16. The capstan 14 is rotatable between two positions to switch the strike between a power to open mode and a power to lock mode as will later be described.

Capstan 14 sits in housing 18 in which it is free to rotate, and also free to move to the left and the right upon activation or deactivation of solenoid 16. Solenoid 16 includes a plunger 20 which is urged to the left in the drawings when electric power is applied which in turn causes lateral movement of capstan 14 against the pressure of spring 24 of microswitch 22. Spring 24 biases the capstan 14 and plunger 20 to the right as seen in the drawings and operates to return capstan 14 and plunger 20 to their original positions when power to the solenoid is interrupted.

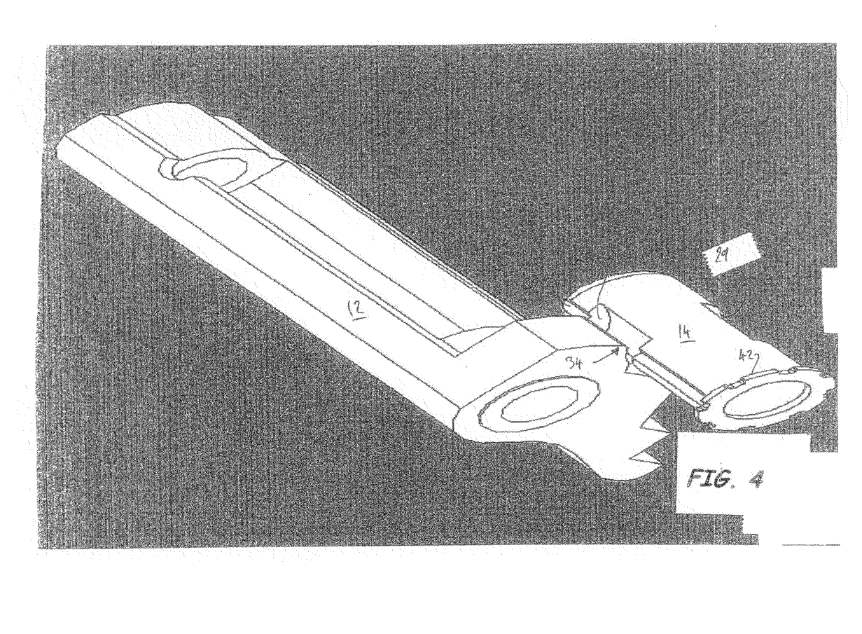

Referring now to FIG. 4, capstan 14 and keeper 12 are shown in isolation and are in the same positions as in FIG. 1. The cylindrical part of capstan 14 bears two recesses 28 and 29. In use the position of either of recesses in relation to keeper 12 dictates whether or not keeper is free to move. If one or other of recesses 28, 29 is aligned with lug 34 of keeper 12 then the lug is free to pass by the capstan by way of the recess and thus the keeper is allowed to rotate.

Referring again to FIG. 3, recess 28 is aligned with lug 34 and thus the keeper is free to rotate. The strike is thus in the power to lock mode.

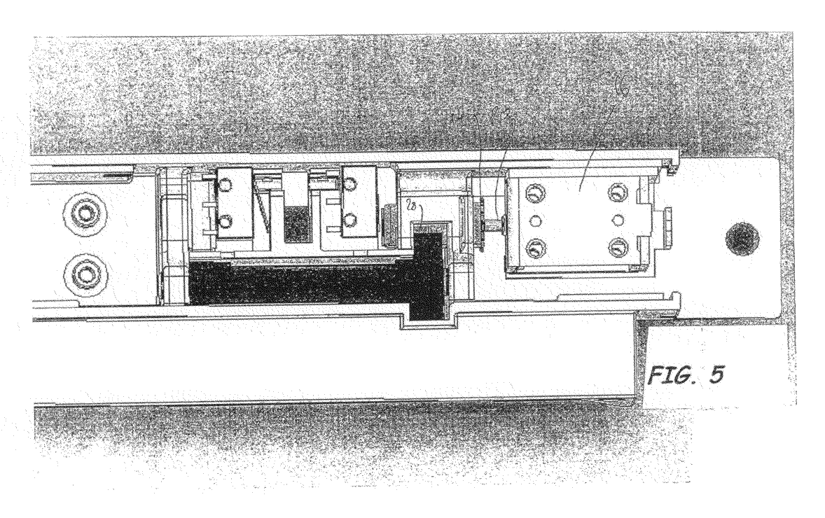

Referring now to FIG. 5, power is being applied to solenoid 16 and it can be seen that plunger 20 of solenoid has moved capstan 14 to the left as shown in the drawings. Recess 28 now does not align with lug 34. Instead, capstan 14 obstructs lug 34 and so keeper 12 is not free to rotate and the strike is locked.

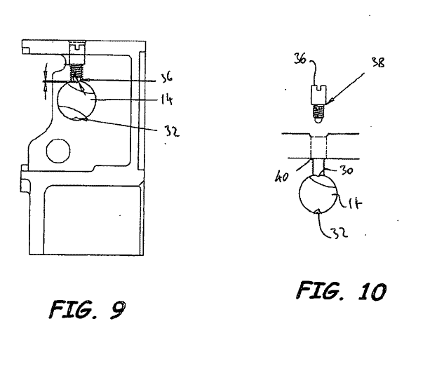

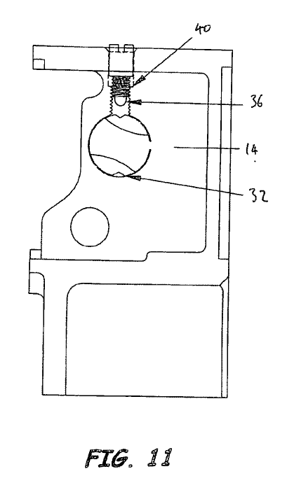

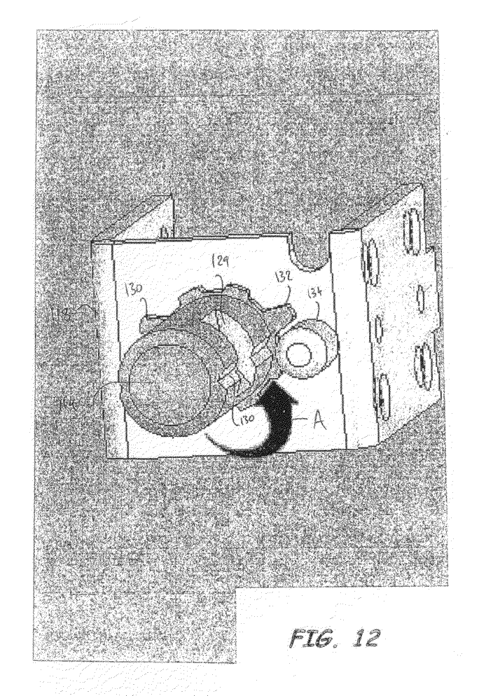

Referring now to FIGS. 9, 10 and 11, capstan 14 is rotatable between two positions to provide either power to lock or power to open modes of operation. Capstan 14 is maintained in either of the two positions by way of set screws 36 sitting in either of grooves 30 or 32. The set screws are mounted in threaded holes provided in the body of the strike. FIG. 9 shows set screw 36 sitting in groove 30. Each of set screws 36 have a shoulder 38 which abuts against stop 40 provided in each of the threaded holes to limit the depth of insertion of set screws 36 into the body of the strike. In FIG. 9 screw 36 is fully inserted with shoulder 38 abutting stop 40. In this position, the tip of the set screw sits in groove 30 with about 0.5 mm clearance between the tip of screw 36 and the capstan 14. Thus, even when fully inserted, screws 36 do not press onto capstan 14 and capstan 14 remains free to move to the left and right upon activation of solenoid 16. In order to rotate capstan 14, set screws 36 must first be withdrawn a number of turns until the tip of screw 36 is out of engagement with groove 30. Capstan 14 has a series of castellations 42 about one end. A small tool such as a screwdriver can be inserted through a slot in the strike to rotate capstan 14 by pushing on castellations 44.

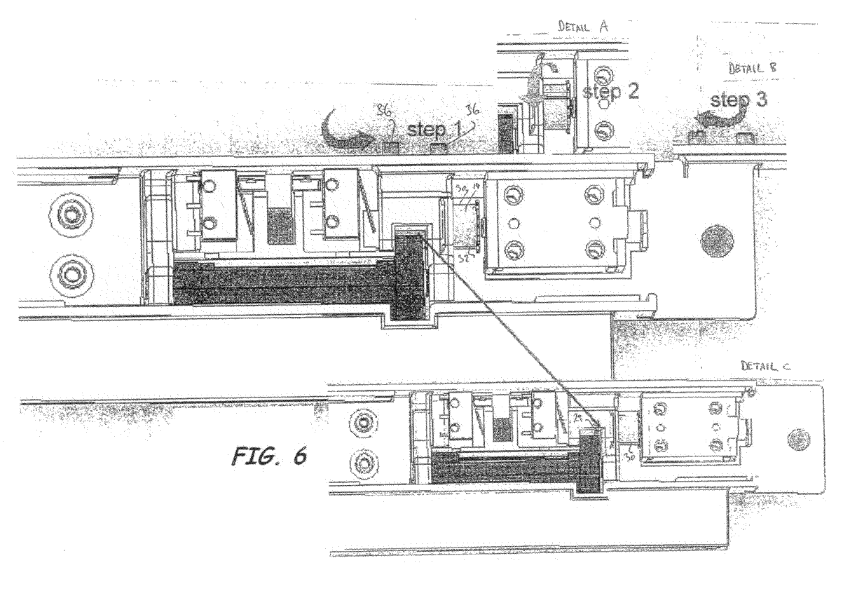

Referring to FIG. 6, the process of switching the strike from power to lock mode to power to open mode is illustrated. At step 1 two set screws 36 are loosened to bring them out of groove 30. At step 2 a small screwdriver is used to rotate capstan 14 through 180 degrees by way of castellations 42 to line groove 32 up with set screws 36 (see detail A). At step 3 set screws 36 are screwed back into the strike to sit in groove 32 (See detail B). The strike is now in the power to open mode (See Detail C).

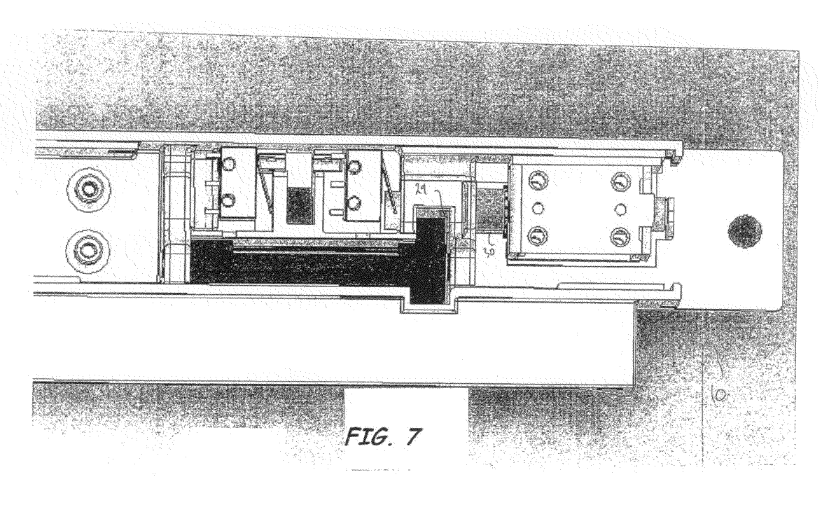

Referring to FIG. 7, strike 10 is shown in the power to open mode with no power applied. It can be seen that recess 29 does not align with lug 34. Instead, capstan 14 obstructs lug and so keeper cannot move.

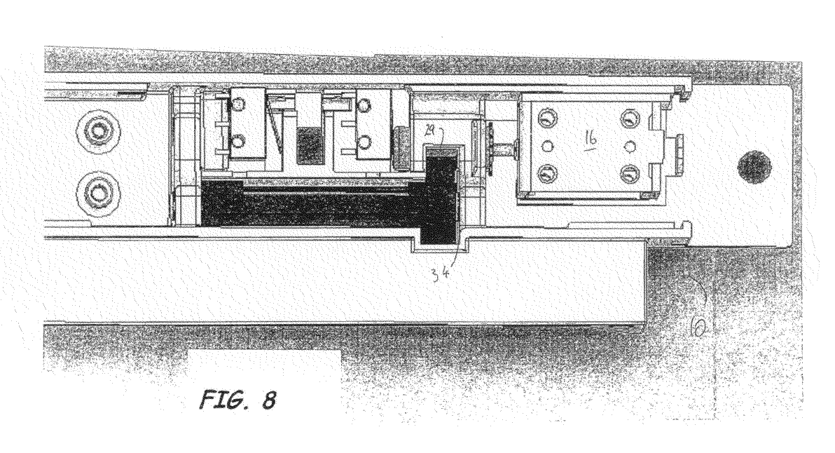

Referring to FIG. 8, strike 10 is shown in the power to open mode with power applied to solenoid 16. It can be seen that recess 29 aligns with lug 34 and keeper is free to rotate to allow the door to open.

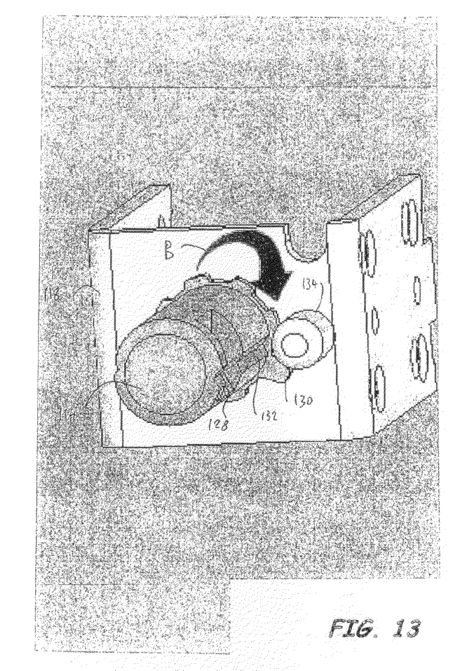

Referring to FIGS. 12 and 13, an alternative version of capstan 114 is shown rotatably mounted in a housing 118. This version of capstan 114 differs to the one described above in that it features an aligning means which includes two arms in the form of elongated castellations 130, 132 which cooperate with a stop 134 to align either of grooves 130, 132 with the set screws to improve ease of switching modes of the lock as will now be described.

In FIG. 12 it can be seen that elongated castellation 132 abuts stop 134. In this position groove 130 is aligned with set screws (not shown). The capstan is now only permitted to turn anticlockwise as indicated by arrow A. If capstan is turned in the direction of arrow A then the other elongate castellation 130 comes around to abut the other side of stop 134 as shown in FIG. 13. When castellation 130 abuts stop 134 the set screws (not shown) are aligned with groove 132. Now, capstan may only rotate clockwise in the direction shown by arrow B. In this way, a user is not required to visually align the grooves with the capstan screws as was the case with the lock described above. Instead the user simply loosens the set screws and rotates the capstan in whichever direction it is permitted to rotate until the capstan comes up against a stop and then re-tightens the capstan screws.

In a still further embodiment, the alignment means takes to the form of one elongated castellation and two stops. The capstan is allowed to rotate between the two stops and when it is at either stop the lock is either in the power to open or power to lock mode and the set screws are aligned with the appropriate one of the grooves on the capstan.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A door strike including:
a latch retainer for retaining a door latch;
a lock actuator which operates when power is applied;
a mode selector rotatable between at least two positions;
in a first position of the mode selector the strike adopts a power to open mode, in the second position of the mode selector the strike adopts a power to lock mode.

2. A door strike according to claim 1 wherein the mode selector includes at least two recesses which cooperate with a lug associated with the latch retainer.

3. A door strike according to claim 2 wherein the recesses are provided about a generally cylindrical portion of the mode selector.

4. A door strike according to claim 1 wherein the mode selector includes at least two grooves which dictate the at least two positions of the mode selector.

5. A door strike according to claim 4 wherein at least one set screw may sit in either of the grooves to retain the mode selector in either of the at least two positions.

6. A door strike according to claim 1 wherein the latch retainer is pivotally mounted in the door strike.

7. A door strike according to claim 1 further including alignment means which aligns the mode selector in at least one of the first or second positions.
